(19) United States
(12) Patent Application Publication
(10) Pub. No.: US 2008/0304021 A1
(43) Pub. Date: Dec. 11, 2008

(54) LIGHT-SHIELDING MODULE AND PROJECTION APPARATUS USING THE SAME

(75) Inventors: Chih-Chien Lin, Hsinchu (TW); Jean-Yuan Lin, Hsinchu (TW); Chien-Yi Chen, Hsinchu (TW); Pin-Chun Huang, Hsinchu (TW); Chih-Lu Hsu, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/870,143

(22) Filed: Oct. 10, 2007

(30) Foreign Application Priority Data
Jun. 6, 2007 (TW) 96209299

(51) Int. Cl. G02B 26/02; G03B 21/14

(52) U.S. Cl. 353/97; 359/230

(57) ABSTRACT

A light-shielding module including a bracket, a pendulous member, a shielding member, a first magnet, a second magnet and a first coil is provided. The pendulous member has a first end and a second end opposite to each other and is pivoted on the bracket. The first end extends along a direction from a pivoting place of the pendulous member to a top of the bracket. The shielding member is connected to the first end. The first magnet is disposed at the pendulous member and located between the pivoting place and the first end. The second magnet is disposed at the pendulous member and adjacent to the second end. A mass-of-center of the second magnet is located beside a center line passing a center-of-mass of the first magnet and the pivoting center. The first coil is disposed on one of the first side wall and the second side wall.

### CROSS-REFERENCE TO RELATED APPLICATION

This application claims the priority benefit of Taiwan application serial no. 96209299, filed Jun. 6, 2007. All disclosure of the Taiwan application is incorporated herein by reference.

### BACKGROUND OF THE INVENTION

1. Field of the Invention

The present invention generally relates to a projection apparatus and, more particularly, to a light-shielding module of a projection apparatus and a projection apparatus using the same.

2. Description of Related Art

In order to advance image quality in the prior art, a dynamic black technique is used, where a projection lens is cut out to form an opening, so that a shielding member is able to be switched into the projection lens to block a part of a light beam. The shielding member moves with the different luminance of a frame to change the contrast of the frame and further to promote the image quality.

FIGS. 1A and 1B are schematic perspective diagrams respectively showing a bottom view and a top view of a conventional light-shielding module 100. Referring to FIGS. 1A and 1B, the light-shielding module 100 includes a yoke 110, a first magnet 120, a second magnet 130, a coil 140, a shielding member 150, a pendulous member 160 and a spring coil 170. The first magnet 120 and the second magnet 130 are fixed at the yoke 110 and are opposite to each other, and the N pole of the first magnet 120 and the S pole of the second magnet 130 face to each other, while the S pole of the first magnet 120 and the N pole of the second magnet 130 face to each other. In addition, the pendulous member 160 has a pivoting hole 162 and the pendulous member 160 is pivoted on a shaft (not shown) through the pivoting hole 162. The coil 140 is connected between the pendulous member 160 and the shielding member 150, while the spring coil 170 is connected between the pendulous member 160 and the yoke 110.

In the prior art, a current is fed to the coil 140 to enable the magnetic field generated between the first magnet 120 and the second magnet 130 to drive the coil 130 to swing. In this way, the pendulous member 160 and the shielding member 150 are driven to swing by means of the coil 140. Besides, by changing the current fed to the coil 140, the swing angle of the shielding member 150 is adjustable, so that the shielding member 150 is switched into or away from the transmission path of the light beam. When no current is fed in, the restoring force of the spring coil 170 makes the pendulous member 160 return back to a predetermined position.

To initiate the swing of the pendulous member 160, larger current is needed to overcome the elastic action of the spring coil 170 to swing the pendulous member 160, which not only wastes energy, but also results in overheating and damaging the coil 140. In addition, the spring coil 170 tends to be fatigued due to continuous actions thereof. As a result, the driving current gets excessive and the pendulous member 160 fails to be swung to the predetermined position. In short, the light-shielding module 100 is easily out of order due to the fatigue of the spring coil 170, which leads the contrast to decrease, so as to lower the image display quality.

On the other hand, the coil 140 is connected to a circuit board (not shown) through a flexible printed circuit board (FPCB) (not shown), so that a control unit of the light-shielding module 100 feeds current to the coil 140 through the FPCB to swing the pendulous member 160. However, during the swing of the coil 140, the FPCB is accordingly moved and bended, and the elastic bending restoring force and the length of the FPCB interferes with the swing of the coil 140. For example, if the FPCB is too short, the coil 140 would not smoothly swing. For overcoming the problem, the current fed to the coil 140 is increased, which not only wastes energy, but also results in overheating and damaging the coil 140. If the FPCB is too long, the FPCB tends to interfere with the swing of the pendulous member 160.

### SUMMARY OF THE INVENTION

Accordingly, the present invention is directed to a light-shielding module to solve the problem of easily failing to run normally due to elastic fatigue of the spring coil in the prior art.

Other advantages of the present invention are further indicated by the disclosures of the present invention. To achieve one of, a part of or all of the above-mentioned advantages, or to achieve other advantages, an embodiment of the present invention provides a light-shielding module capable of being switched into a transmission path of a light beam to block the light beam. The light-shielding module includes a bracket, a pendulous member, a shielding member, a first magnet, a second magnet, a first coil and a control unit. The bracket has a first side wall and a second wall opposite to each other. The pendulous member is pivoted on the bracket and has a first end and a second end opposite to the first end, and the first end extends along a direction from a pivoting place of the pendulous member to a top of the bracket. The shielding member is connected to the first end and capable of being switched in the transmission path of the light beam. The first magnet is disposed at the pendulous member and located between the pivoting place and the first end. End faces of the two poles of the first magnet respectively face the first side wall and the second side wall. The second magnet is disposed at the pendulous member and adjacent to the second end. A center-of-mass of the second magnet is located beside a center line passing a center-of-mass of the first magnet and a center of the pivoting place, and End faces of the two poles of the second magnet respectively face the top and a bottom of the bracket. The first coil is disposed on one of the first side wall and the second side wall.

According to an embodiment of the present invention, an optical apparatus is disclosed. The optical apparatus, for example, a projection apparatus, includes an illumination system, a projection lens, a light valve and the above-mentioned light-shielding module. The illumination system is capable of providing a light beam, and the projection lens is disposed on a transmission path of the light beam. The light valve is disposed on the transmission path of the light beam between the illumination system and the projection lens. In addition, the light-shielding module is disposed on the projection lens.

Since the first magnet and the second magnet are located asymmetrically to the pivoting place of the pendulous member, the magnetic force generated between the first magnet and the second magnet are used to swing the pendulous member to a predetermined position. The design without spring coil is capable of solving the problem of easily failing to run normally due to fatigue of the spring coil of the light-shielding module as in case of the prior art.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic perspective diagrams respectively showing a bottom view and a top view of a conventional light-shielding module.

FIG. 2 is a schematic diagram of a projection apparatus according to an embodiment of the present invention.

FIG. 3A is a schematic perspective diagram of the light-shielding module in FIG. 2.

FIG. 3B is an exploded diagram of the light-shielding module in FIG. 3A.

FIG. 4 is a schematic cross-sectional diagram of the light-shielding module in FIG. 3A.

FIG. 5 is a schematic cross-sectional diagram of a light-shielding module according to another embodiment of the present invention.

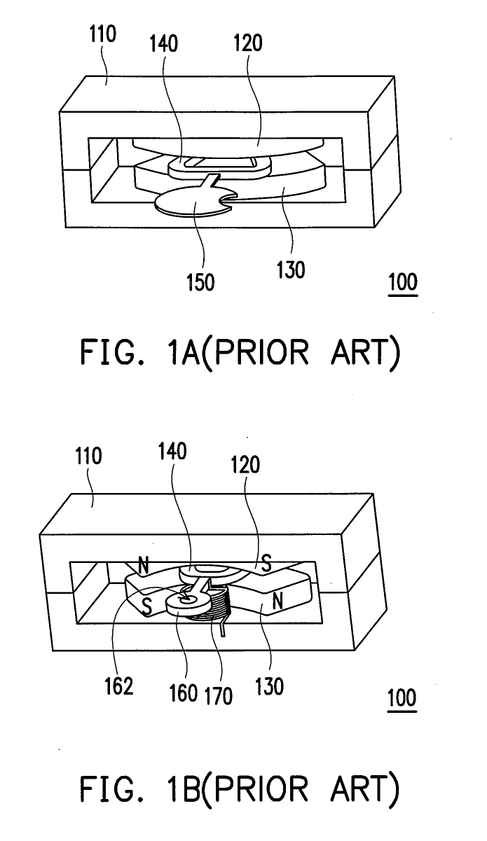

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

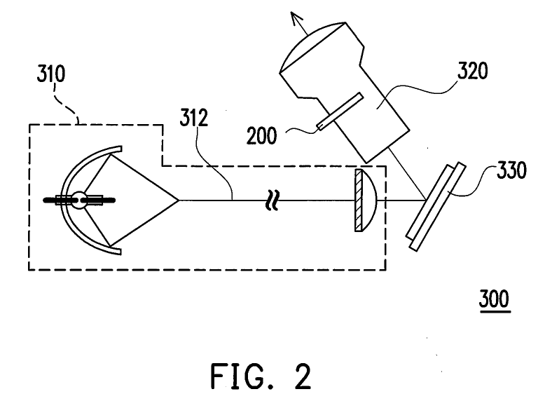

Referring to FIG. 2, a projection apparatus 300 according to an embodiment of the present invention includes an illumination system 310, a projection lens 320, a light valve 330 and a light-shielding module 200. The illumination system 310 is capable of providing a light beam 312. The projection lens 320 and the light valve 330 are disposed on a transmission path of the light beam 312 and between the illumination system 310 and the projection lens 320. The light-shielding module 200 is disposed on the projection lens 320.

In the above-mentioned projection apparatus 300, the light valve 330 is, for example, a digital micro-mirror device (DMD), a liquid crystal on silicon panel (LCOS panel) or other types of light valves. The projection lens 320 is used for projecting the light beam 312 onto a screen (not shown). The light-shielding module 200 operates in response to the image signal and blocks a part of the light beam 312 at an appropriate time with the luminance change of the display frame, so as to change the contrast of the frame on the screen to improve the image quality.

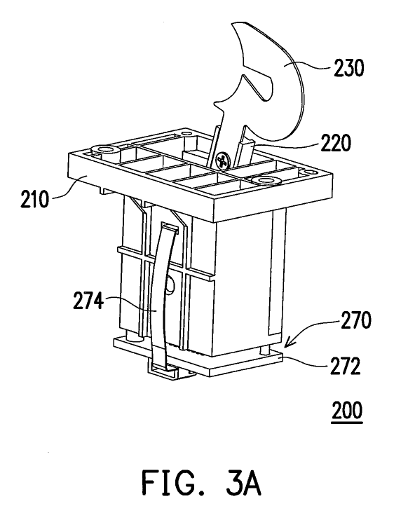

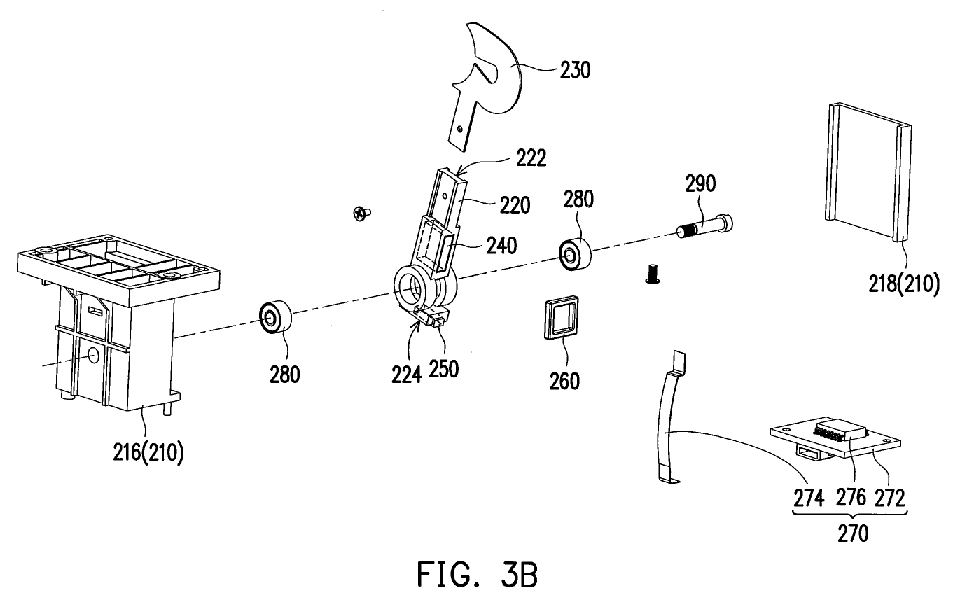

Referring to FIGS. 3A, 3B and 4, the above-mentioned light-shielding module 200 includes a bracket 210, a pendulous member 220, a shielding member 230, a first magnet 240, a second magnet 250, a first coil 260 and a control unit 270. The bracket 210 has a first side wall 212 and a second side wall 214 opposite to each other. The pendulous member 220 is pivoted at the bracket 210 and has a first end 222 and a second end 224 opposite to the first end 222. The first end 222 extends along a direction from a pivoting place 226 of the pendulous member 220 to a top of the bracket 210. The shielding member 230 is connected to the first end 222 of the pendulous member 220 and capable of being switched into the transmission path of the light beam 312 shown in FIG. 2.

The first magnet 240 is disposed at the pendulous member 220 and located between the pivoting place 226 and the first end 222. End faces of the two poles of the first magnet 240 respectively face the first side wall 212 and the second side wall 214. In addition, the second magnet 250 is disposed at the pendulous member 220 and adjacent to the second end 224. A center-of-mass of the second magnet 250 is located beside a center line 50 passing a center-of-mass of the first magnet 240 and a center of the pivoting place 226, and End faces of the two poles of the second magnet 250 respectively face the top and a bottom of the bracket 210. The first coil 260 is disposed on the first side wall 212 of the bracket 210, but may be disposed on the second side wall 214 as well. The control unit 270 is electrically connected to the first coil 260 and is capable of feeding a current to the first coil 260 to drive the pendulous member 220 to swing.

In the above-mentioned light-shielding module 200, the bracket 210 is, for example, formed by combining a first sub-assembly 216 and a second sub-assembly 218. The end face of the N pole of the first magnet 240 faces, for example, the first side wall 212, while the end face of the S pole thereof faces, for example, the second side wall 214. The end face of the S pole of the second magnet 250 faces, for example, the top of the bracket 210, while the N pole thereof faces, for example, the bottom of the bracket 210. In addition, the center-of-mass of the second magnet 250 is, for example, located between the center line 50 and the first side wall 212, and the end face of the first magnet 240 facing the first side wall 212 of the bracket 210 has a magnetic polarity opposite to a magnetic polarity of the end face of the second magnet 250 facing the top of the bracket 210. The pivoting place 226 of the pendulous member 220 is, for example, at least a pivoting hole, while the light-shielding module 200 further includes at least a bearing 280 and a fixed shaft 290. The bearing 280 is disposed at the pivoting place 226 of the pendulous member 220, while the fixed shaft 290 passes through the bearing 280 and is fixed at the bracket 210. The shielding member 230 and the pendulous member 220 is integrally formed for example.

In the embodiment, since the center-of-mass of the second magnet 250 is located between the center line 50 and the first side wall 212, the pendulous member 220 is deflected to the first side wall 212 when no current is fed to the first coil 260. Besides, the pull between the N pole of the first magnet 240 and the S pole of the second magnet 250 also drives the pendulous member 220 to swing towards the first side wall 212 and makes the pendulous member 220 lean on the first side wall 212, and, at the time, the position of the pendulous member 220 is just the predetermined position thereof. In the present embodiment, when the pendulous member 220 is at the predetermined position, the shielding member 230 is unable to block the light beam 312.

As shown in FIG. 4, to make the shielding member 230 switch into the transmission path of the light beam 312, the control unit 270 outputs a current I₁ to the first coil 260 to generate a push between the first coil 260 and the N pole of the first magnet 240, which pushes the pendulous member 220 to swing towards the second side wall 214, so that the shielding member 230 is switched into the transmission path of the light beam 312 and blocks a part of the light beam 312. To make the shielding member 230 switch away from the transmission path of the light beam 312, the control unit 270 outputs a current with a flowing direction opposite to the current I₁ to the first coil 260 to generate a pull between the first coil 260 and the N pole of the first magnet 240, which pulls the pendulous member 220 to swing towards the first side wall 212, so that the shielding member 230 is switched away from the transmission path of the light beam 312.

In the present embodiment, the control unit 270 includes a circuit board 272, a current-transferring unit 274 and a magnetic sensor 276 disposed on the circuit board 272. The current-transferring unit 274 is, for example, a FPCB connected between the circuit board 272 and the first coil 260. The circuit board 272 is capable of feeding the current to the first coil 260 through the current-transferring unit 274. The magnetic sensor 276 is used for sensing the second magnet 250. When the magnetic sensor 276 senses magnetic force variations corresponding to different swing positions of the pendulous member 220, the positions of the pendulous member 220 may be converted therefrom by calculation and a position signal is then sent back to the circuit board 272. In more detail, the swing scope of the pendulous member 220 may be divided into 256 steps. The circuit board 272 uses the sent-back signal to control the amount and direction of the current fed to the first coil 260, so as to make the pendulous member 220 swing to an expected position.

Since the light-shielding module 200 of the present embodiment does not need a spring coil to make the pendulous member 220 swing to the predetermined position, which prevents the problem of failing to run normally due to fatigue of the spring coil. As a result, the light-shielding module 200 of the present embodiment has longer lifetime and better stability. In addition, the present embodiment uses the magnetic force between the first magnet 240 and the second magnet 250 to swing the pendulous member 220 back to a predetermined position, which is a non-contact design, and therefore, a structural interference is avoided. Furthermore, since the first coil 260 is not a moving part, the problem of the FPCB easily interfering with the swing of the coil in the prior art is avoided. Moreover, by using the magnetic sensor 276 to sense the position of the pendulous member 220, a misjudgement due to a position error caused by the assembly tolerance of the pendulous member 220 is prevented, which allows the light-shielding module 200 of the present embodiment to have a larger assembly tolerance, saves the assembly labor hours and promotes the production efficiency.

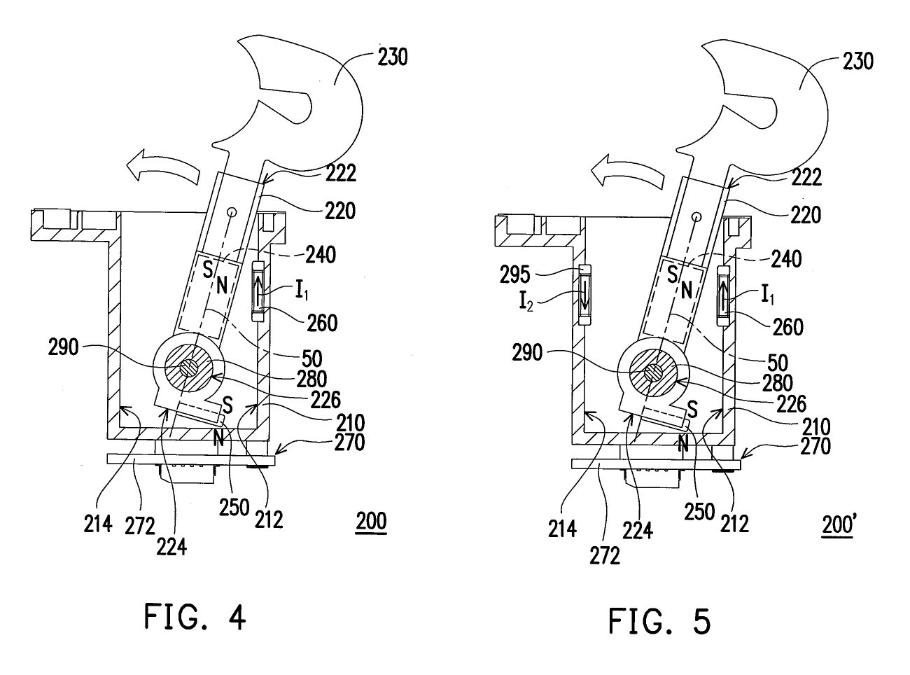

Referring to FIG. 5, a light-shielding module 200′ according to another embodiment of the present invention is similar to the light-shielding module 200 shown in FIG. 4, except for the differences described below. The light-shielding module 200′ further includes a second coil 295 disposed on the second side wall 214 of the bracket 210 and opposite to the first coil 260. The second coil 295 is electrically connected to the circuit board 272 through the current-transferring unit 274.

To make the shielding member 230 switch into the transmission path of the light beam 312, the control unit 270 feeds a current I₁ to the first coil 260 and feeds another current I₂ with a flowing direction opposite to that of the current I₁ to the second coil 295 to generate a push between the first coil 260 and the N pole of the first magnet 240 and a pull between the second coil 295 and the S pole of the first magnet 240. In this way, the pendulous member 220 is driven to swing towards the second side wall 214, so that the shielding member 230 is switched into the transmission path of the light beam 312 to block a part of the light beam 312. To make the shielding member 230 switch away from the transmission path of the light beam 312, the control unit 270 feeds a current with a flowing direction opposite to that of the current I₁ to the first coil 260 and feeds another current with a flowing direction opposite to that of the current I₂ to the second coil 295 to generate a pull between the first coil 260 and the N pole of the first magnet 240 and a push between the second coil 290 and the S pole of the first magnet 240. In this way, the pendulous member 220 is driven to swing towards the first side wall 212, so that the shielding member 230 is switched away from the transmission path of the light beam 312 and the swing of the pendulous member 220 is smoother and more stable. It should be noted that the second coil 295 can be replaced by a third magnet (not shown) as well, where a pull and a push between the third magnet and the first coil 260 are used to drive the pendulous member 220 to swing.

In summary, the present invention has at least following advantages:

1. The present invention does not need a spring coil to swing back the pendulous member to the predetermined position, which is able to avoid the problem of failing to run normally due to elastic fatigue of the spring coil and to make the light-shielding module of the present invention have longer lifetime and better stability.

2. The present invention is a non-contact design by using magnetic force to swing back the pendulous member to the predetermined position, which avoids structural interference.

3. Since the first coil is not a moving part, the problem of the FPCB easily interfering with the swing of the coil as in the case of the prior art is avoided.

4. By using the magnetic sensor to sense the position of the pendulous member, a misjudgement due to a position error of the pendulous member caused by the assembly tolerance is prevented, which allows the light-shielding module of the present invention to have a larger assembly tolerance, saves the assembly labor hours and promotes the production efficiency.

The above described are preferred embodiments of the present invention only, which do not limit the implementation scope of the present invention. It will be apparent to those skilled in the art that various modifications and equivalent variations can be made to the structure of the present invention without departing from the scope or spirit of the invention. In view of the foregoing, it is intended that the present invention covers modifications and variations of this invention provided they fall within the scope of the following claims and their equivalents. In addition, any one of the embodiments of the present invention or any one of the claims is not necessarily to achieve all the objectives, all the advantages or all the features disclosed by the present invention. Moreover, the abstract of the disclosure and the title are intended to aid paten searching, not to limit the claim scope of the present invention.

What is claimed is:

1. A light-shielding module, adapted to an optical apparatus, the light-shielding module comprising:
a bracket, having a first side wall and a second side wall opposite to each other;
a pendulous member, pivoted on the bracket and having a first end and a second end opposite to the first end, wherein the first end extends along a direction from a pivoting place of the pendulous member to a top of the bracket;
a shielding member, connected to the first end of the pendulous member, for being switched into a transmission path of a light beam generated by the optical apparatus;
a first magnet, disposed at the pendulous member and located between the pivoting place and the first end, wherein end faces of two poles of the first magnet respectively face the first side wall and the second side wall;
a second magnet, disposed at the pendulous member and adjacent to the second end, wherein a center-of-mass of the second magnet is located beside a center line passing a center-of-mass of the first magnet and a center of the pivoting place, and end faces of two poles of the second magnet respectively face the top and a bottom of the bracket; and
a first coil, disposed on one of the first side wall and the second side wall.

2. The light-shielding module according to claim 1, further comprising a control unit electrically connected to the first coil, wherein the control unit is capable of feeding a current to the first coil to drive the pendulous member to swing.

3. The light-shielding module according to claim 2, wherein the control unit comprises:
a circuit board;
a current-transferring unit, connected between the circuit board and the first coil, wherein the circuit board is capable of feeding the current to the first coil through the current-transferring unit; and
a magnetic sensor, disposed on the circuit board, for sensing variations of a magnetic force as the pendulous member swings.

4. The light-shielding module according to claim 1, wherein the center-of-mass of the second magnet is located between the center line and the first side wall, and the end face of the first magnet facing the first side wall of the bracket has a magnetic polarity opposite to a magnetic polarity of the end face of the second magnet facing the top of the bracket.

5. The light-shielding module according to claim 1, further comprising:
a bearing, disposed at the pivoting place of the pendulous member; and
a fixed shaft, passing through the bearing and fixed at the bracket.

6. The light-shielding module according to claim 1, further comprising a second coil, wherein one of the first coil and the second coil is disposed on the first side wall, while the other one is disposed on the second side wall, and the second coil is electrically connected to the control unit.

7. The light-shielding module according to claim 1, further comprising a third magnet, wherein the third magnet and the first coil are respectively disposed on the first side wall and the second side wall.

8. The light-shielding module according to claim 1, wherein the shielding member and the pendulous member are integrally formed.

9. A projection apparatus, comprising:
an illumination system, capable of providing a light beam;
a projection lens, disposed on a transmission path of the light beam;
a light valve, disposed on the transmission path of the light beam and between the illumination system and the projection lens;
a light-shielding module, comprising:
a bracket, disposed on the projection lens and having a first side wall and a second side wall opposite to each other;
a pendulous member, pivoted on the bracket and having a first end and a second end opposite to the first end, wherein the first end extends along a direction from a pivoting place of the pendulous member to a top of the bracket;
a shielding member, connected to the first end of the pendulous member, for being switched into the transmission path of the light beam;
a first magnet, disposed at the pendulous member and located between the pivoting place and the first end, wherein end faces of two poles of the first magnet respectively face the first side wall and the second side wall;
a second magnet, disposed at the pendulous member and adjacent to the second end, wherein a center-of-mass of the second magnet is located beside a center line passing a center-of-mass of the first magnet and a center of the pivoting place, and end faces of two poles of the second magnet respectively face the top and a bottom of the bracket; and
a first coil, disposed on one of the first side wall and the second side wall.

10. The projection apparatus according to claim 9, further comprising a control unit electrically connected to the first coil, wherein the control unit is capable of feeding a current to the first coil to drive the pendulous member to swing.

11. The projection apparatus according to claim 10, wherein the control unit comprises:
a circuit board;
a current-transferring unit, connected between the circuit board and the first coil, wherein the circuit board is capable of feeding the current to the first coil through the current-transferring unit; and
a magnetic sensor, disposed on the circuit board, for sensing variations of a magnetic force as the pendulous member swings.

12. The projection apparatus according to claim 9, wherein the center-of-mass of the second magnet is located between the center line and the first side wall, and the end face of the first magnet facing the first side wall of the bracket has a magnetic polarity opposite to a magnetic polarity of the end face of the second magnet facing the top of the bracket.

13. The projection apparatus according to claim 9, wherein the light-shielding module further comprises:
a bearing, disposed at the pivoting place of the pendulous member; and
a fixed shaft, passing through the bearing and fixed at the bracket.

14. The projection apparatus according to claim 9, wherein the light-shielding module further comprises a second coil, one of the first coil and the second coil is disposed on the first side wall, while the other one is disposed on the second side wall, and the second coil is electrically connected to the control unit.

15. The projection apparatus according to claim 9, wherein the light-shielding module further comprises a third magnet, and the third magnet and the first coil are respectively disposed on the first side wall and the second side wall.

16. The projection apparatus according to claim 9, wherein the shielding member and the pendulous member are integrally formed.
